(19) United States
(12) Patent Application Publication
(10) Pub. No.: US 2014/0322362 A1
(43) Pub. Date: Oct. 30, 2014

(54) IN SITU PRODUCTION OF A BIOCIDAL BROMINE SPECIES VIA ELECTROLYSIS

(71) Applicant: BROMINE COMPOUNDS LTD., Beer Sheva (IL)

(72) Inventors: Ron Frim, Haifa (IL); Shlomo Antebi, Haifa (IL)

(21) Appl. No.: 14/366,048

(22) PCT Filed: Dec. 19, 2012
(86) PCT No.: PCT/IL2012/050536

§ 371 Date: Jun. 17, 2014

Related U.S. Application Data
(60) Provisional application No. 61/578,920, filed on Dec. 22, 2011.

(51) Int. Cl. C25B 1/24; A01N 59/00

(52) U.S. Cl. CPC C25B 1/24; A01N 59/00
USPC 424/723; 205/551; 204/242

(57) ABSTRACT

This invention provides a one-stage process for generating a biocidal solution in situ, including a reaction between an ammonium salt and an electrolytically generated bromine oxidative species.

### FIELD OF THE INVENTION

The present invention relates to a process of producing a stable active and effective biocidal bromine species in the solution for an immediate need via the electrolysis of bromide or chloride salts in the presence of an ammonium ion.

### BACKGROUND OF THE INVENTION

Active bromine species can be generated in an aqueous environment by electrolysis. For example, EP 476862 and EP 0243846 describe the electro-generation of HOBr by circulating a mixture of chloride and bromide ions through an electrolytic cell. U.S. Pat. No. 5,868,911 and U.S. Pat. No. 5,679,239 describe a process and an apparatus for generating an aqueous solution of active bromine; said process comprises a step of producing bromate ions, and a step of generating an active bromine compound by acidification of said bromate said apparatus comprises an electro-generation system, an electrolyte reservoir, an acid reservoir, an acid-introducing means, an acidification controller, and a mixing reservoir for the product. The known systems are often complex and cumbersome, and they cannot supply the needed biocidal species under various practical circumstances. It is therefore an object of the invention to provide a simplified, one-step process for generating and stabilizing the bromine active species.

It is another object of the invention to provide a feasible system for producing active bromine in an aqueous environment.

It is a still another object of the invention to provide a process for generating active bromine species for various applications in aqueous environment.

It is further an object of the invention to provide a system for generating an active bromine species without need of handling concentrated oxidants, or diluting active solutions.

It is a still further object of the invention to provide active bromine species while complying with requirements on environmental quality and personnel safety.

It is also an object of the invention to provide active bromine species in situ for biocidal treatment and with biocidal activity in solution and as antifouling agent.

Other objects and advantages of present invention will appear as description proceeds.

### SUMMARY OF THE INVENTION

This invention provides a one-stage process for generating biocidal aqueous mixture in situ, comprising the steps of i) providing an aqueous mixture containing at least one bromide salt and at least one ammonium salt in solution; and ii) subjecting said mixture of step i) to electrolysis; thereby obtaining a biocidal mixture for controlling biofouling comprising bromamine. In a preferred embodiment, said electrolysis comprises a DC. Said bromide salt may be, for example, NaBr, KBr, NH₄Br, and other. Said ammonium salt may be, for example, NH₄Cl, (NH₄)₂SO₄, NH₄Br, NH₄OH and other. In a preferred embodiment of the invention, said salts comprise ammonium bromide. In one embodiment, said mixture comprises at least one bromide and at least one chloride. In one preferred embodiment, said mixture contains ammonium bromide. Said biocidal mixture, created during the process of electrolysis preferably comprises at least one haloamine, for example bromamine and chloramine or a combination of an haloamine with a bromide salt. The process of the invention comprises a reaction between an ammonium salt and an electrolytically generated bromine or chlorine oxidative species.

The invention is directed to a biocidal aqueous mixture, preferably for controlling biofouling, comprising active bromine or chlorine species such as bromoamine or bromine and chlorine containing species obtained by the process as described above.

The invention is directed to an apparatus for generating biocidal aqueous mixture, comprising a DC electrolyzing unit and a container for dissolving at least one bromide salt or one chloride salt and at least one ammonium salt in water.

The invention also relates to biocidal solution and its biocidal and antibiofilm properties.

### DETAILED DESCRIPTION OF THE INVENTION

It has now been found that an active biocidal mixture for controlling biofouling can be obtained without dilutions and without handling caustic or corrosive materials in a one-stage process, comprising electrolytical treatment of a solution containing at least one bromide salt and one ammonium salt. The invention provides a surprisingly simple biocidal system which obviates handling dangerous materials, and provides efficient haloamine biocidal species concentrations high enough to eliminate the microbial contamination but low enough to avoid corrosion and safety problems.

The apparatus of the invention simply consists of an electro-generation system and an electrolyte reservoir. The active haloamine species is produced in situ during the electrolysis stage. Bromine is an oxidizing biocide which has been recognized as a superior biocide for many applications.

However the delivery methods for such an oxidizing material are complicated due to strict safety means and regulations. The use of on-site electrolysis according to the invention obviates the problems, as the raw materials needed in the method of the invention like bromides or chlorides are non-hazardous.

The process of the invention provides routes for producing bromamine directly from ammonium bromide, in one preferred embodiment at ambient temperature.

In one aspect of this invention, a method is provided for producing other active haloamines biocidal form that can combine active halogen, haloamines and halide species when starting with a mixture of ammonium salts or a combination of bromide and chloride and ammonium salts.

Common chemicals produced by the electrolysis of salt solutions are chlorine and sodium hydroxide. The principal electrode reactions that occur in the electrolysis (DC power) of salt solutions comprise:

Anode: 2Na+2Cl—=Cl₂+2Na++2e−

Cathode: 2H₂O+2e−=H₂+2OH—

The resulting overall reaction is:

2NaCl+2H₂O=2NaOH+Cl₂+H₂

If employing NH₄Br the equations would be:

Anode: 2NH₄++2Br—=Br₂+2NH₄++2e−

Cathode: 2H₂O+2e−=H₂+2OH—

The resulting overall reaction would be:

2NH₄Br+2H₂O=2NH₄OH+Br₂+H₂

The two products formed in the electrolytic cell are believed to produce

NH₄OH+HBrO=BrNH₂+H₂O+OH—

or

NH₄Br+HBrO=BrNH₂+H₂O+Br—

Haloamines are known biocides which effectively reduce, inhibit and/or control the proliferation of microorganisms that cause biological fouling. Haloamines biocides are typically generated by combining a solution of active halogen donors (e.g. hypochlorite) with an amine containing composition (e.g., ammonium chloride). For example, U.S. Pat. No. 5,976,386 and U.S. Pat. No. 6,132,628 disclose the preparation of haloamine biocides from hypochlorite and various ammonium salts for use in treating liquids to inhibit the growth of microorganisms; the hypochlorite solution is drawn from a reservoir of a pre-prepared solution. The active halogen species, such as hypohalites, are strong, corrosive oxidants, which makes them both difficult and dangerous to handle, especially in large quantities. Furthermore, these species degrade over time, resulting in a continually decreasing level of active halogen, and in lowered potency of the material. Furthermore, the formation of bromamine produced by the disclosed methods requires strict and defined concentration ratios between the two reactants, specific dilution of the solutions, and strict pH control, and it necessitates a special and unique monitoring equipment.

WO 2008/091678 A1 relates to the preparation of haloamines biocides in an integrated apparatus comprising an electrochemical cell and a mixing chamber wherein active halogen donor species are electrochemically generated and subsequently reacted with amine containing compositions to form haloamine biocide; the active halogen donor species is electrochemically generated upon demand in the electrochemical cell, for example from NaCl, and then mixed with an amine containing composition in the mixing chamber.

Haloamines have been electrochemically generated in one step in an electrochemical cell [Trembley-Goutaudier C. et al.: J. Chem. Phys. 91 (1994) 535]. The formation of bromamine, NH₂Br, by electrolysis of ammonium bromide in aqueous ammoniacal solution was studied [Lyalin B. V. et al.: Russian Chem. Bull. 47 (1998) 1956]. Other attempts to electrochemically generate chloramine (NH₂Cl) in one step from ammonia in aqueous NaCl salt solution resulted in very low yields (not exceeding 0.1%).

In a preferred embodiment of the invention, an improved haloamines biocidal species such as bromamine or bromide activated chloramines are prepared directly by the electrolysis of an aqueous solution of ammonium bromide or a combination of bromide and chloride salts in the presence of ammonium salts in one step at 25° C. Caustic materials, such as ammonium hydroxide or sodium hydroxide, may thus be eliminated from the process.

In one embodiment, sulfuric acid is added in a low concentration in order to suppress the formation of bromate ions.

A biocide solution was formed as described and used as an efficient biocide. The direct formation of biocidal haloamines, bromamine and/or species that combine chlorine and bromine based moieties minimizes problems associated with difficult transportation, with material corrosion, and with product degradation. No reservoirs of active halogen donor species need to be filled and maintained. The method of the invention addresses the demanding requirements on the environmental quality and on personnel safety existing in technological practice nowadays.

Ammonium bromide is substantially safer than any biocide in current use, equal to sodium bromide or sodium chloride. The electrolytic biocidal haloamine solution is a potent biocide and possess antibiofouling properties, and is much safer to handle than other products providing similar biocidal effects; it comprises an aqueous solution of exactly needed strength, made on demand and immediately dosed, without a danger of accidental spill. The potential environmental, health and safety hazards associated with any type of accidental discharge are minimized. Furthermore, electrolytically formed haloamines and bromamine based species degrade back to harmless products after use (Br— and N₂). The method according to the invention complies with the modern requirements on green chemistry procedures.

The present invention thus relates to an apparatus and methods comprising electrochemical production of an aqueous mixture comprising haloamines, bromamine or a mixture of haloamines or species that combine bromamine or chloramines and halides containing at least one active bromine compound, to control growth of microorganisms in aqueous systems. Particularly, the invention relates to an electrochemical apparatus for the production of the mixtures of the haloamines and the derived biocidal solution and its application mode. More particularly, the present invention relates to an electrochemical apparatus and method to produce mixtures or combinations of haloamines, and halide and haloamine mixtures comprising at least one biocidal bromine or chlorine compound in said mixture.

The invention provides a one-step process in which the aqueous solution contains a bromide ion, with or without a chloride ion, in the presence of an ammonium ion or amine, leading to the production of an active solution comprising activated haloamines or bromamine. This solution is used for killing microorganisms and controlling biofouling in high chlorine demand environment. In one embodiment, aliphatic amines may be comprised in the mixture.

In the known methods, the formation of similar biocidal species requires a strict pH control to prevent undesired by-products build-up, such as when formed in the presence of alkali or alkali earth bromide salts in the electrolytic process.

This invention relates to an improved process for generating an aqueous solution containing at least one active bromine compound which may be used in water treatment.

The invention thus provides a feasible, environmentally friendly and simple, system for producing an active biocide in an aqueous environment. Provided is a process for generating such species for various applications in aqueous environment, without need of handling concentrated oxidants or diluting active solutions. The active halogen species in optimal concentrations are obtained, while complying with requirements on environmental quality and personnel safety. Particularly, active bromine species for biocidal treatment is provided in situ.

While the invention has been described using some specific examples, many modifications and variations are possible. It is therefore understood that the invention is not intended to be limited in any way, other than by the scope of the appended claims.

1. A one-stage process for generating biocidal aqueous mixture, comprising the steps of
i) providing an aqueous mixture containing at least one bromide salt and at least one ammonium salt in solution; and
ii) subjecting said mixture of step i) to electrolysis;
thereby obtaining a biocidal mixture for controlling biofouling.

2. A one-stage process for generating biocidal aqueous mixture in situ, comprising the steps of
i) providing an aqueous mixture containing at least one bromide salt and at least one ammonium salt in solution; and
ii) subjecting said mixture of step i) to electrolysis;
thereby obtaining a biocidal mixture for controlling biofouling, the mixture comprising active species with superior biocidal and antifouling properties selected from haloamines, bromamine, and a combination of haloamines and halides.

3. A process according to claim 1, wherein said electrolysis comprises a DC.

4. A process according to claim 1, wherein said bromide salts comprise ammonium bromide.

5. A process according to claim 1, wherein said mixture comprises at least one bromide and at least one chloride.

6. A process according to claim 1, wherein said biocidal mixture comprises at least two haloamines.

7. A process according to claim 1, comprising a reaction between an ammonium salt and an electrolytically generated bromine oxidative species.

8. A biocidal aqueous mixture comprising bromoamine obtained by the process of claim 1.

9. An apparatus for generating biocidal aqueous mixture by the process of claim 1, comprising
i) a DC electrolyzing unit; and
ii) a container for dissolving at least one bromide salt and at least one ammonium salt in water.

10. A biocidal solution obtained by the process according to claim 1 with superior biocidal and antifouling properties.
